(19) United States
(12) Patent Application Publication
(10) Pub. No.: US 2018/0084235 A1
(43) Pub. Date: Mar. 22, 2018

(54) AUDIO AND VIDEO PROJECTION SYSTEM

(71) Applicant: Tymphany HK Limited, Wanchai (HK)

(72) Inventors: CHAU WING HONG, Wanchai (HK); RUBEN MINORU MILYARD, Wanchai (HK)

(21) Appl. No.: 15/711,573

(22) Filed: Sep. 21, 2017

Related U.S. Application Data
(60) Provisional application No. 62/397,916, filed on Sep. 21, 2016.

(51) Int. Cl. H04N 9/31; H04R 1/02; G10K 11/16

(52) U.S. Cl. CPC H04N 9/3173; H04R 1/028; H04R 2499/15; G10K 11/16; H04N 9/3144

(57) ABSTRACT

A portable audio video system, includes a cabinet having a first space and a second space, a video projection unit arranged in the first space, a first speaker arranged in the second space, the first speaker operative to receive an audio signal from an audio source, and a first passive radiator assembly arranged in the second space.

### CROSS-REFERENCE TO RELATED APPLICATIONS

The following application is a non-provisional application that claims priority to provisional application number 62/397916 filed on Sep. 21, 2016, the contents of which are incorporated by reference herein in its entirety.

### TECHNICAL FIELD

The present disclosure relates to audio and visual applications, and more specifically, to a stand-alone video projection system that provides audio as well as video output.

### BACKGROUND

Video and audio consumption is at an all-time high. Some sources estimate that American adults consumed approximately five and a half hours of video content per day in 2015. Access to such content is easier, more convenient, and less expensive than it has ever been. Online streaming services are ubiquitous and video enabled devices are ever present, for example, mobile telephones, tablets, electronic readers, televisions, etc.

However, certain players may provide sufficient video output, but compromise on audio quality. Vice versa, some devices provide enhanced audio but lack in video performance. Moreover, many devices which do provide sufficient audio and video output are not portable. Televisions, for the most part, are effectively immobile. Wall mounted units especially, cannot even be readily moved around a room or within a house.

Conventional video projectors simply do not include an audio component. In these systems, audio must be provided by a peripheral device which must be connected to the projector and independently powered and operated. Some newer projector systems have tried to incorporate audio. However, in these systems, audio quality is negligible at best, and cost is excessive. Additionally, portability of these systems is limited because they require an AC power source and they are not configured to withstand travel, whether, and the outdoors. Moreover, current designs lack an aesthetic and tend look awkward in a room and stand out negatively amongst other electronic devices.

What is needed is a projector system which avoids the disadvantages noted above. More specifically, what is need is a projector system that provides high quality audio and video within a single device, which takes power into consideration, that may be portable, and that has a refined and integrated appearance for a non-obtrusive and elegant indoor appearance.

### SUMMARY

According to an exemplary embodiment, a portable audio video system includes a cabinet having a first space and a second space, a video projection unit arranged in the first space, a first speaker arranged in the second space, the first speaker operative to receive an audio signal from an audio source, and a first passive radiator assembly arranged in the second space.

According to another exemplary embodiment, a sound bar system includes a cabinet having a first space and a second space, a video projection unit arranged in the first space, a first speaker arranged in the second space, the first speaker operative to receive an audio signal from an audio source, and a first passive radiator assembly arranged in the second space.

### BRIEF DESCRIPTION OF THE DRAWING

For a more complete understanding of this disclosure, reference is now made to the following brief description, taken in connection with the accompanying drawings and detailed description, wherein like reference numerals represent like parts:

FIG. 1 illustrates a top view of an exemplary embodiment of an audio video (A/V) system.

FIG. 2 illustrates a top partially cut-away view of the exemplary embodiment of the A/V system.

FIG. 3 illustrates a bottom view of the exemplary embodiment of the A/V system.

FIG. 4 illustrates a block diagram of portions of the processing and I/O portion.

FIG. 5 illustrates a top partially cut away view of another exemplary embodiment of an A/V system.

### DETAILED DESCRIPTION

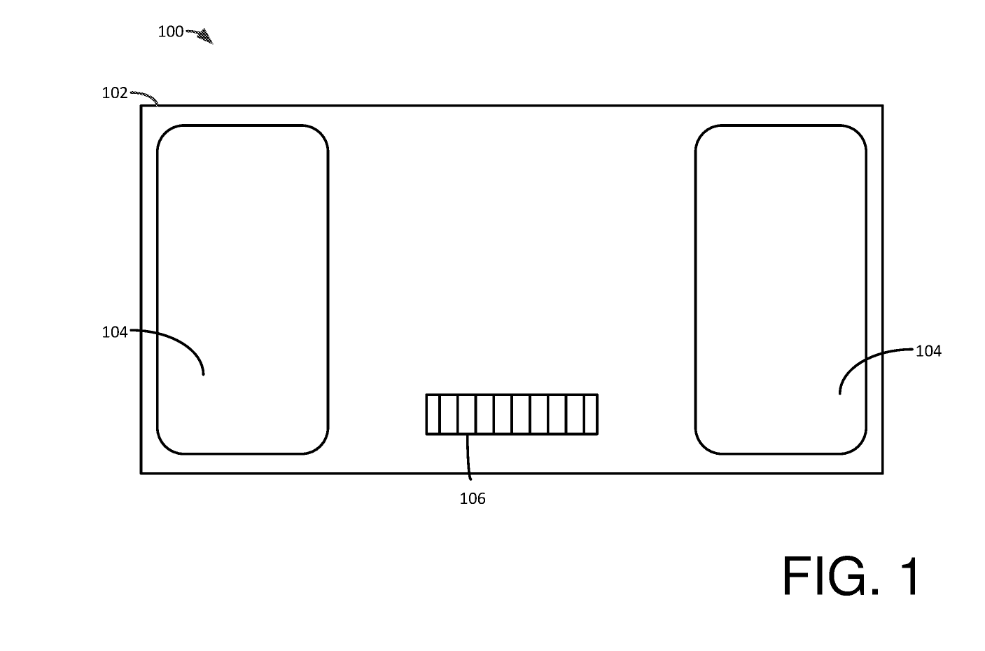

FIG. 1 illustrates a top view of an exemplary embodiment of an audio video (A/V) system 100.

Referring to FIG. 1, the A/V system 100 includes a cabinet 102. Mounted to the cabinet as shown in FIG. 1 are two passive radiator assemblies 104. An exhaust vent 106 may be arranged on the cabinet 102 to allow for thermal ventilation.

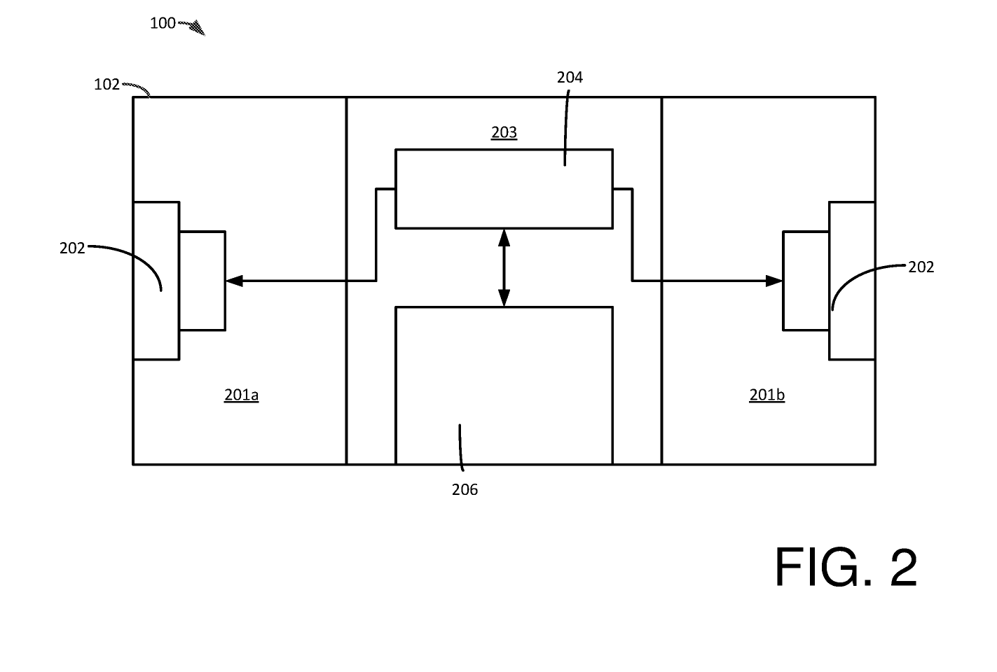

FIG. 2 illustrates a top partially cut-away view of the exemplary embodiment of the A/V system 100. The A/V system 100 includes the cabinet 102 that may be fabricated from any suitable material including, for example, a wooden, composite, plastic, or polymer material. The cabinet 102 has at least three spaces 201a, 201b, and 203 that may, in some embodiments be substantially sealed such that air does not substantially pass or transfer between the spaces 201a, 201b, and 203.

The A/V system 100 includes a processing and input/output (I/O) portion 204, which will be explained in further detail below. The processing and I/O portion 204 is communicatively connected to the speakers 202 and the projector 206. The processing and I/O portion 204 may be communicatively connected to any suitable A/V source device (not shown) that may provide audio or video or both audio or video via a wired or wireless connection. The processing and I/O portion 204 is communicatively connected to the speakers 202 and the projector 206.

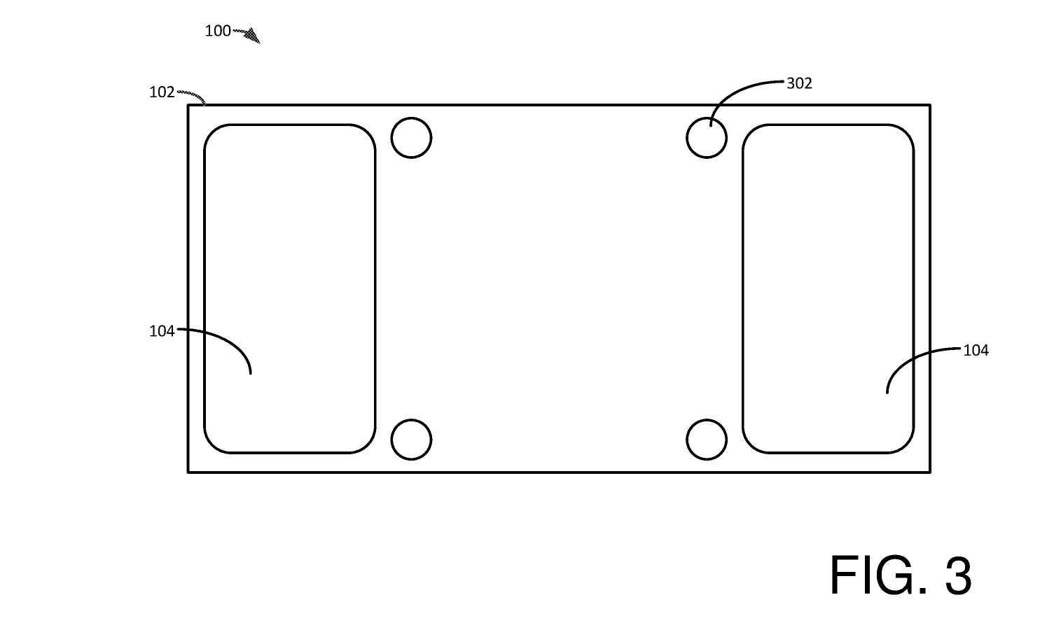

FIG. 3 illustrates a bottom view of the exemplary embodiment of the A/V system 100. The bottom view illustrates additional passive radiator assemblies 104 that may be arranged on the bottom surface of the cabinet 102. Feet or risers 302 are arranged on the bottom surface of the cabinet 102 to provide clearance for the passive radiator assemblies 104 to operate.

In this regard, the passive radiator assemblies 104 include material and structure similar to the cones of an active speaker assembly. The passive radiator assemblies 104 are operative to reduce vibrations in the cabinet 102 that may be caused by the operation of the speakers 202 (of FIG. 2). The passive radiator assemblies 104 may improve the video performance by reducing the vibrations in the cabinet 102, which improves the stability of the projected video image. The passive radiator assemblies 104 may also improve the acoustic performance of the A/V system 100 by, for example, improving the bass sound of the A/V system 100. The movement of the passive radiator assemblies 104 may also act as reflex ports to improve the base frequency response of the A/V system 100.

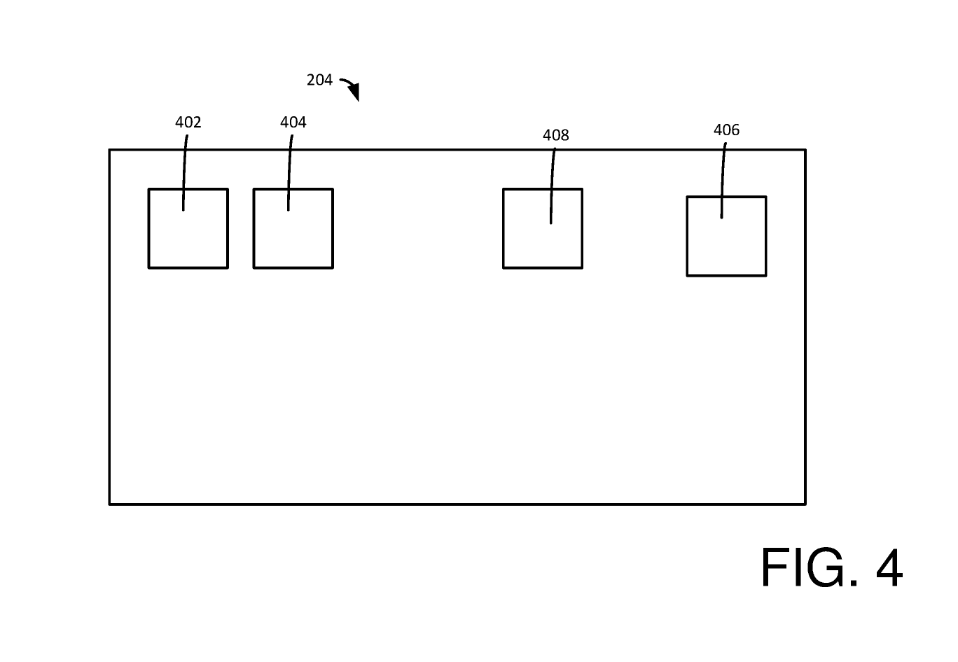

FIG. 4 illustrates a block diagram of portions of the processing and I/O portion 204. The processing and I/O portion 204 includes, for example, a processor 402. The processor 402 may include an integrated audio digital signal processor engine. The processing and I/O portion 204 may further include an audio power amplifier 404. The audio portion of the A/V system 100 may further include a special acoustic component combination, for example, a combination of transducers such as woofer, tweeter, full range and passive radiator.

The A/V system 100 may further optionally include an acoustic port to cool an engine of the projector, thus minimizing noise provide by a fan (not shown).

The processing and I/O portion 204 can additionally include a multichannel audio decoding capability, with multichannel virtualization in order to provide immersive sound.

The A/V system 100 may also include wireless or wired subwoofer output, with a wireless or wired full range output for wireless rear channels.

The A/V system 100 may further include an integrated accelerometer which is disposed and configured to detect the position of the system. The system is configured to then adjust the projection orientation of video and adjust the audio setting for a specific position.

In one exemplary embodiment, the A/V system 100 is configured to be highly portable in that it is configured to operation on both AC power and battery power (from a battery 406). Additionally, in this portable embodiment, the A/V system 100 may be waterproof so that it can be used outdoors in various weather conditions.

The A/V system 100 includes an input/output portion 408 that may include any suitable connections, hardware, firmware, and software to provide a wired or wireless analogue or digital connection to an audio or video content source.

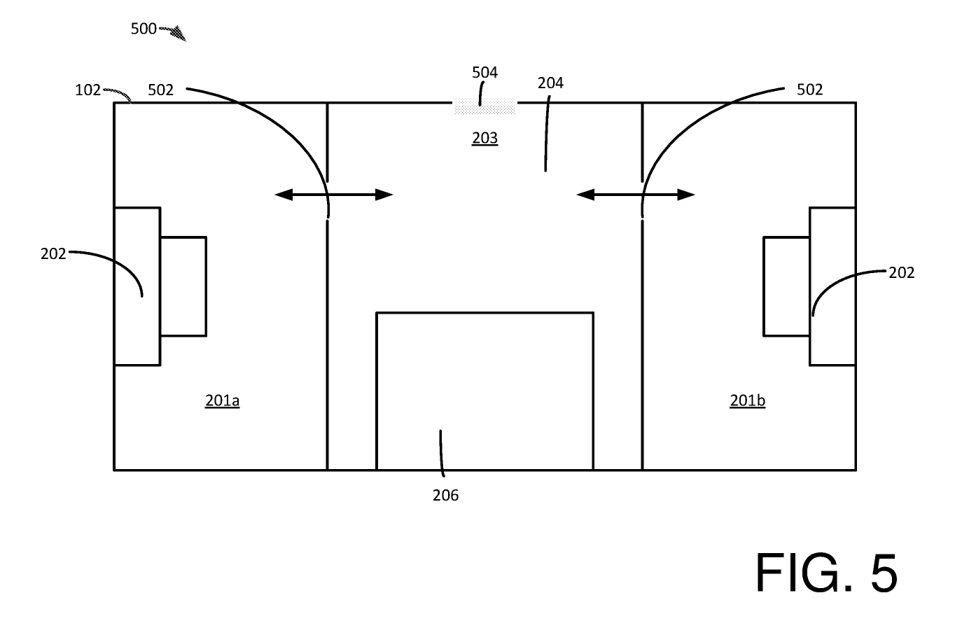

FIG. 5 illustrates a top partially cut away view of another exemplary embodiment of an A/V system 500. The system 500 includes an orifice or communicative passage (acoustic port) 502 between the space 201a and 203. In some exemplary embodiments, a passage 502 may be arranged between the spaces 203 and 201b.

In this portable version, the acoustic port 502 mentioned above plays an important role. The port 502 not only provides a pathway for sound output, but also for external air to circulate through the device and especially around the projector engine and around any audio components which may generate heat. This provides a cooling to the device, without requiring a fan or at least minimizing the role thereof. As a result, the A/V system consumes less energy and experiences a longer operational time per battery charge.

The A/V 100 system is fully configured to engage wirelessly in order to receive audio and/or video content and to communicate with and operate peripheral devices such as wireless speakers, surrounds, subwoofers, etc. Wireless communication and control may be via a Wi-Fi network generated by the A/V system 100 or a shared Wi-Fi network, or via Bluetooth, or any other wireless communication means. Wireless connectivity allows the A/V system 100 to be operated and managed by a user's mobile phone, laptop computer, or other wireless enable device.

The A/V system 500 may include an acoustic port 504 that may allow the communication of air between the second cavity 203 and the ambient air external to the cavity 102. Such an acoustic port 504 may provide improved audio performance, and also provide passage of cooling air that may cool the electronic components of the A/V system 100.

Audio quality provided by the A/V system 100, and particularly the portable embodiment, is exceptional. The system includes a specific chip in order to increase the audio quality.

In another embodiment, the A/V system 100 may be integrated within a sound bar, a piece of furniture, a structural building element such as a wall, floor, ceiling, column, soffit, etc., or in another electronic device, etc. The sound bar is an elongated device, typically configured to provide audio output and to be used in conjunction with, for example, a television. Here, the sound bar device includes the projector and audio unit disclosed herein, along with a power source (either an AC connection or an internal battery). The sound bar A/V system 100 may be placed anywhere within a room in order to provide high end audio and video output, and the device may be readily moved about the space as desired. In this way, a single device provides video projection, audio output, and power. No set up is required and the single device becomes a full home theatre solution.

In another configuration, the A/V system 100 is integrated within a piece of furniture oriented near a wall or screen. Then, as desired, high quality audio and video may be produced.

The A/V system 100, and particularly, the embodiment in which the system is integrated within a sound bar, provides immersive sound from a multichannel source using, for example, a multichannel virtualizer in order to provide a full home theatre experience from a single unit, with no setup required. All that is needed is a white wall and video source.

While the preferred embodiments to the invention have been described, it will be understood that those skilled in the art, both now and in the future, may make various improvements and enhancements which fall within the scope of the claims which follow.

These claims should be construed to maintain the proper protection for the invention first described.

What is claimed is:

1. A portable audio video system, comprising:
a cabinet having a first space and a second space;
a video projection unit arranged in the first space;
a first speaker arranged in the second space, the first speaker operative to receive an audio signal from an audio source; and
a first passive radiator assembly arranged in the second space.

2. The system of claim 1, further comprising:
a third space;
a second speaker arranged in the second space, the second speaker operative to receive an audio signal from the audio source; and
a second passive radiator assembly arranged in the third space.

3. The system of claim 2, wherein the first space is arranged between the second space and the third space.

4. The system of claim 1, further comprising a third passive radiator assembly arranged in the second space.

5. The system of claim 2, further comprising a fourth passive radiator assembly arranged in the third space.

6. The system of claim 1, wherein the first space is sealed from the second space.

7. The system of claim 1, wherein the first space is communicative with the second space.

8. The system of claim 1, further comprising an integrated audio digital signal processor (DSP) configured to enhance quality of an audio output; and
acoustic components including at least one of a woofer, tweeter, full range and passive tweeter.

9. The system of claim 1, further comprising a power system comprising a battery and/or AC supply.

10. The system of claim 1, wherein the system is water resistant.

11. A sound bar system, comprising:
a cabinet having a first space and a second space;
a video projection unit arranged in the first space;
a first speaker arranged in the second space, the first speaker operative to receive an audio signal from an audio source; and
a first passive radiator assembly arranged in the second space.

12. The sound bar system of claim 11, further comprising:
a third space;
a second speaker arranged in the second space, the second speaker operative to receive an audio signal from the audio source; and
a second passive radiator assembly arranged in the third space.

13. The sound bar system of claim 12, wherein the first space is arranged between the second space and the third space.

14. The sound bar system of claim 11, further comprising a third passive radiator assembly arranged in the second space.

15. The sound bar system of claim 12, further comprising a fourth passive radiator assembly arranged in the third space.

16. The sound bar system of claim 11, wherein the first space is sealed from the second space.

17. The sound bar system of claim 11, wherein the first space is communicative with the second space.

18. The sound bar system of claim 11, further comprising an integrated audio digital signal processor (DSP) configured to enhance quality of an audio output; and
acoustic components including at least one of a woofer, tweeter, full range and passive tweeter.

19. The sound bar system of claim 11, further comprising a power system comprising a battery and/or AC supply.

20. The sound bar system of claim 11, wherein the system is water resistant.
